(19) United States
(12) Patent Application Publication
(10) Pub. No.: US 2009/0264334 A1
(43) Pub. Date: Oct. 22, 2009

(54) Cleaning compositions

(76) Inventors: Maria Luisa Ferreyra, Buenos Aires (AR); Eleonora Maldacena, Buenos Aires (AR)

Correspondence Address: UNILEVER PATENT GROUP, 800 SYLVAN AVENUE, AG West S. Wing, ENGLEWOOD CLIFFS, NJ, 07632-3100, US

(21) Appl. No.: 11/989,168

(22) PCT Filed: Jul. 17, 2006
(86) PCT No.: PCT/EP2006/007038

§ 371 Date: Jan. 22, 2008

(30) Foreign Application Priority Data
Jul. 22, 2005 (BR) 0503023-4
Nov. 11, 2005 (EP) 05077560.0

(51) Int. Cl. C11D 1/37; C11D 1/94

(52) U.S. Cl. 510/420

(57) ABSTRACT

The present invention discloses cleaning compositions comprising a combination of surfactants and viscosity modifying agent including electrolyte, that upon dilution thickens so as to form a gel. The compositions are useful for household cleaning activities such as dishwashing. They provide enhanced and progressive retention of surfactant in carriers, thus avoid excessive product consumption and providing more yield.

### FIELD OF THE INVENTION

The present invention relates to cleaning compositions, to their preparation, to cleaning methods and to processes for enhancing the retention of cleaning agents into carriers. More specifically, the invention relates to cleaning compositions for use in hand dishwashing.

### BACKGROUND OF THE INVENTION

Liquid household cleaning products that provide thickening upon dilution are known in the art, as detailed in the following references:

U.S. Pat. No. 5,922,664 describes a composition comprising a micellar dispersion of a mixture of at least two anionic surfactants having different resistance to electrolytic salting out, and alkali metal citrate. The attained viscosity upon dilution does not go beyond 1,400 mPas.

EP 314,232 mentions a composition of: (a) a primary surfactant chosen from amine, amine oxide, betaine or quaternary ammonium compounds, preferably an amine oxide, (b) a hydrotrope co-surfactant compound, e.g. ethanol, methanol or triethanol-amine, and (c) a water-ionisable non-surfactant compound, e.g. inorganic acids, neutral salts or alkali.

WO 96/32464 discloses a kit comprising a sponge and a water-thickening surfactant composition based on electrolyte concentration. This document also shows the viscosity profile of the disclosed compositions, wherein the viscosity peak reaches 1,685 mPas, which is only 2.7 times higher than the initial viscosity of 620 mPas.

Prior art documents teach simple compositions that can reach high viscosities upon dilution, improving its use in situations similar to manual dishwashing. However, prior art compositions present technical and/or economical bottlenecks that are solved by the present invention, such as obtaining cleaning compositions having enhanced retention in a carrier and/or high viscosity upon dilution, even at high dilution rates. These and other technical problems described above are solved by the present invention.

### SUMMARY OF THE INVENTION

In one aspect there are provided compositions with enhanced retention of its cleaning agents (surfactants) in a carrier upon dilution. These compositions have advantages over the prior art, such as lower consumption of the cleaning composition in use, thus giving better yield, being more economical in use and being environmentally friendly. The enhanced retention of cleaning agent in a carrier also decreases the time spent in refilling the carrier, so that the cleaning compositions of the invention are faster and more efficient in use. Furthermore, the advantages of the compositions of the invention allow a more rational use of containers for cleaning compositions.

The compositions according to the invention, which comprise surfactants and viscosity modulating agents, do not decrease in viscosity upon addition of a diluent, but rather increase in viscosity. For hand dishwashing such compositions preferably have a low viscosity initially and only increase in viscosity after addition of a certain amount of diluent. This allows penetration of the composition through the pores of a porous carrier, while at the same time keeping the composition within the carrier for a longer period. The selective way by which the composition of the invention behaves provides an advantageous balance between low initial viscosity, maximum viscosity and final viscosity, as well as provides an advantageous balance between viscosity increasing ratio (between minimum and maximum viscosity) and viscosity decreasing ratio (between maximum and final viscosity).

In another aspect, there are described cleaning compositions that provide increased viscosity upon dilution even at high dilution rates.

In another aspect, there are provided cleaning compositions having low initial viscosity so as to easily penetrate into a carrier.

The cleaning compositions comprise a mixture of surfactants and viscosity modulating agents and other optional ingredients and provide:
low initial viscosity so as to easily penetrate into a carrier;
viscosity increase upon dilution after penetrating into said carrier, so that the cleaning compositions stay longer within the carrier, thus providing enhanced performance even after repeatedly rinsing;
on dilution the cleaning composition becomes a stable and transparent gel; and
controlled and sustained release of surfactants.

In another aspect there is provided a cleaning method for surfaces, particularly hard surfaces, which is more efficient and economic than the previously known cleaning methods.

In yet another aspect there is provided a process for enhancing the retention of cleaning agents into carriers such as sponges and the like.

### DETAILED DESCRIPTION OF THE INVENTION

The invention provides dilution-thickening aqueous liquid cleaning compositions comprising:
one or more surfactants;
one or more viscosity modulating agents.

More specifically, the invention provides dilution-thickening aqueous liquid cleaning compositions comprising:
at least two anionic surfactants which are both alkalimetal alkylether sulphates;
at least one electrolyte as a viscosity modulating agent;
   wherein the ratio of the amount of surfactants to the amount of electrolyte is between about 4.3 and about 12.

Preferred ratios are from about 9 to about 11.

### Surfactants

The compositions of this invention require at least one surfactant which may be selected among anionic, amphoteric, zwitterionic and nonionic surfactants and combinations thereof. Preferably the compositions of the invention comprise at least one anionic surfactant and at least another surfactant selected among anionic, amphoteric, zwitterionic and nonionic surfactants and combinations thereof.

### Anionic Surfactants

Useful anionic surfactants are for instance alkali metal, ammonium or alkanolammonium salts of organic reaction products having an aliphatic alkyl, alkenyl or alkyl-aromatic group with about 8 to about 18 carbon atoms and at least one water-solubilizing radical selected from the group consisting of phosphate, phosphonate, sulfonate, sulfate or carboxylate.

Examples of suitable anionic surfactants useful in the present invention include the sodium, potassium, ammonium, mono-, di- and triethanolammonium salts of; C₈-C₁₈ alkyl phosphates, C₈-C₁₈ alkyl ether phosphates with 1 to 25 moles of alkylene oxide, C₈-C₁₈ acyl isethionates, C₈-C₁₈ acylether isethionates with 1 to 25 moles of alkylene oxide, C₈-C₁₈ acyl taurinates, C₈-C₁₈ acylether taurinates with 1 to 25 moles of alkylene oxide, C₈-C₁₈ alkyl benzene sulfonates, C₈-C₁₈ alkyl ether benzene sulfonates with 1 to 25 moles of alkylene oxide, C₈-C₁₈ alkyl paraffin sulfonates (primary and secondary), C₈-C₁₈ alkanolamide sulfates, C₈-C₁₈ alkanolamide ether sulfates with 1 to 25 moles of alkylene oxide, C₈-C₁₈ alkyl α-sulfo-monocarboxylates, C₈-C₁₈ alkyl glyceryl sulfates, C₈-C₁₈ alkyl glyceryl ether sulfates with about 1 to about 25 moles of alkylene oxide, C₈-C₁₈ alkyl glyceryl sulfonates, C₈-C₁₈ alkyl glyceryl ether sulfonates with 1 to 25 moles of alkylene oxide, C₈-C₁₈ alkylether methylcarboxylates with 1 to 25 moles of alkylene oxide, C₈-C₁₈ alkyl sarcosinates/glycinates/hydrolysates, C₈-C₁₈ monoalkyl sulfosuccinates, C₅-C₁₀ dialkyl sulfosuccinates, C₅-C₁₀ dialkyl sulfosuccinamates, C₈-C₁₈ α-olefin sulfonates, C₈-C₁₈ alkyl sulfates and C₈-C₁₈ alkyl ether sulfates with 1 to 25 moles of alkylene oxide.

### Amphoteric Surfactants

There are two classes of amphoteric surfactants: those that are pH sensitive (amphoteric) and those that are pH insensitive (zwitterionic). Suitable amphoteric surfactants are derivatives of aliphatic secondary and tertiary amines which contain a quaternary ammonium or non-quaternary ammonium group and one long chained alkyl or alkenyl group having about 8 to about 18 carbon atoms and at least one water solubilizing radical selected from the group consisting of sulfates, sulfonates, carboxylates, phosphates or phosphonates.

Examples of such amphoteric surfactants include the N-alkyl-β-amino propionates, such as sodium (dodecyl-β-amino) propionate (sodium lauraminopropionate), diethanolamine lauraminopropionate and sodium cocoaminopropionate; the N-alkyl-β-imino dipropionates, such as disodium(dodecyl-β-imino)dipropionate (sodium lauriminodipropionate) and cocoiminodipropionate; the alkyl taurinates, such as monoethanolammonium coconut taurinate as taught in U.S. Pat. No. 2,658,072 and the derivatives of 2-alkyl-2-imidazoline, such as those sold under the trade name Miranol as taught in U.S. Pat. Nos. 2,528,378, 2,773,068, 2,781,354 and 2,781,357. The amphoteric imidazoline-derived surfactants are a preferred class of amphoteric surfactants and are prepared by condensing aminoethylethanolamine, diethylenetriamine or ethylenediamine with a fatty acid having about 8 to about 18 carbon atoms to form a five-membered imidazoline ring which may be ionized by an anionizable alkylating agent such as sodium chloroacetate, methyl or ethyl acrylate, acrylic acid, 2-hydroxy-1,3-propane sultone, 3-chloro-2-hydroxy-propane sulfonic acid and 1,3-propane sultone on or near the cyclic portion or cationic portion of the molecule. Alkylations may be done with or without solvent or in aqueous solution. In aqueous solution, the imidazoline ring may be hydrolytically opened to form a mixture of imidazoline and linear amide. Specific examples of amphoteric imidazoline-derived surfactants useful in the present invention include lauroamphocarboxypropionate, lauroamphopropionate, lauroamphoglycinate, lauroamphocarboxyglycinate, lauroamphopropylsulfonate, lauroamphocarboxypropionic acid, myristoamphocarboxy-propionate, myristoamphopropionate, myristoamphoglycinate, myristoamphocarboxyglycinate, myristoamphopropylsulfonate, myristoamphocarboxypropionic acid, cocoamphocarboxypropionate, cocoamphopropionate, cocoamphoglycinate, cocoamphocarboxyglycinate, cocoamphopropylsulfonate, cocoamphocarboxypropionic acid and mixtures thereof. The CTFA adopted name for this class of amphoteric surfactant is amphoteric-1 through 20. Preferred are amphoteric-1, amphoteric-2, amphoteric-6, amphoteric-10, amphoteric-12, amphoteric-17, amphoteric-18, amphoteric-19 and amphoteric-20.

### Zwitterionic Surfactants

Suitable zwitterionic surfactants are exemplified as those which can be broadly described as derivatives of aliphatic quaternary ammonium, sulfonium and phosphonium compounds with one long chain group having about 8 to about 18 carbon atoms and at least one water solubilizing radical selected from the group consisting of sulfate, sulfonate, carboxylate, phosphate or phosphonate. A general formula for these compounds is:

R₁(R₂)ₓY⁺R₃Z⁻

wherein R₁ contains an alkyl, alkenyl or hydroxyalkyl group with 8 to 18 carbon atoms, from 0 to 10 ethylene-oxy groups or from 0 to 2 glyceryl units; Y is a nitrogen, sulfur or phosphorous atom; R₂ is an alkyl or hydroxyalkyl group with 1 to 3 carbon atoms; x is 1 when Y is a sulfur atom and 2 when Y is a nitrogen or phosphorous atom; R₃ is an alkyl or hydroxyalkyl group with 1 to 5 carbon atoms and Z is radical selected from the group consisting of sulfate, sulfonate, carboxylate, phosphate or phosphonate.

Examples of such zwitterionic surfactants include the sulfatobetaines, such as 3-(dodecyldimethylammonium)-1-propane sulfate and 2-(cocodimethylammonium)-1-ethane sulfate; the sulfobetaines, such as 3-(dodecyldimethylammonium)-2-hydroxy-1-propane sulfonate, 3-(tetradecyldimethylammonium)-1-propane sulfonate, 3-(C₁₂-C₁₄ alkylamidopropyldimethylammonium)-2-hydroxy-1-propane sulfonate, 3-(cocodimethylammonium)-1-propane sulfonate; the carboxybetaine such as (dodecyldimethylammonium)acetate (lauryl betaine), (tetradecyldimethylammonium)acetate (myristyl betaine), (cocodimethylammonium)acetate (coconut betaine), (oleyldimethylammonium) acetate (oleyl betaine), (dodecyloxymethyldimethylammonium) acetate, (cocoamidopropyldimethylammonium)acetate (also known as cocoamidopropyl betaine or CAPB); the sulfoniumbetaines such as (dodecyldimethylsulfonium) acetate and 3-(cocodimethylsulfonium)-1-propane sulfonate and the phosphoniumbetaines such as 4-(trimethylphosphonium)-1-hexadecane sulfonate, 3-(dodecyldimethylphosphonium)-1-propanesulfonate, 2-(dodecyldimethylphosphonium)-1-ethane sulfate and mixtures thereof.

### Nonionic Surfactants

Useful nonionic surfactants include the condensation products of hydrophobic alkyl, alkenyl, or alkyl aromatic compounds bearing functional groups having free reactive hydrogen available for condensation with hydrophilic alkylene oxide, such as ethylene oxide, propylene oxide, butylene oxide, polyethylene oxide or polyethylene glycol to form nonionic surfactants. Examples of such functional groups include hydroxy, carboxy, mercapto, amino or amido groups.

Examples of useful hydrophobes of commercial nonionic surfactants include C₈-C₁₈ alkyl fatty alcohols, C₈-C₁₄ alkyl phenols, C₈-C₁₈ alkyl fatty acids, C₈-C₁₈ alkyl mercaptans, C₈-C₁₈ alkyl fatty amines, C₈-C₁₈ alkyl amides and C₈-C₁₈ alkyl fatty alkanolamides. The polyoxyalkylene condensation products of such materials may comprise from 1 to 100 alkylene oxide groups, preferably from 2 to about 60 alkylene oxide groups, even more preferably from 3 to about 25 alkylene oxide groups. Accordingly, suitable ethoxylated fatty alcohols may be chosen from ethoxylated cetyl alcohol, ethoxylated ketostearyl alcohol, ethoxylated isotridecyl alcohol, ethoxylated lauric alcohol, ethoxylated oleyl alcohol and mixtures thereof.

The compositions according to the invention preferably comprise at least one anionic surfactant. Particularly useful anionic surfactants are C₁₀-C₁₈ alkylether sulphate salts, particularly alkalimetal or ammonium salts, more particularly alkalimetal salts, for instance sodium lauryl ether sulfate (SLES). Preferably, the average ethoxylation level of the anionic surfactant or surfactants vary from about 1 from about 4. More preferably, the composition of the invention comprises at least two anionic surfactants. The second anionic surfactant is preferably also a C₁₀-C₁₈ alkylether sulphate salt. Even more preferably the weight ratio between both anionic surfactants is between about 0.9 and about 1.1. Most preferably, the average ethoxylation level of the first anionic surfactant is about 1, and the ethoxylation level of the second anionic surfactant is about 2.

In a further preferred embodiment the compositions according to the invention also comprise an amphoteric surfactant, particularly a (C₁₀-C₁₈ alkyl)-amidopropyl betaine, such as cocoamidopropylbetaine (CAPB) or laurylamidopropyl betaine.

A useful weight ratio between the amount of anionic surfactant and the amount of amphoteric surfactant is from about 1.3 to about 1.9, more particularly from about 1.4 to about 1.6 or from about 1.64 to about 1.84. The amphoteric surfactants are preferably used in an amount of about 10-18% by weight of the total composition, most preferably 11.3 to 14.6% by weight.

In a most preferred embodiment of the invention, the anionic surfactants are SLES 1EO and SLES 2EO, the amphoteric surfactant is CAPB, and the ratio in weight between them is from about 9:9:11.3 to about 11:11:14.6.

Furthermore the compositions according to the invention usefully contain a nonionic surfactant which is preferably a C₈-C₁₈ ethoxylated alcohol with 3-12 EO groups.

### Viscosity Modulating Agents

The compositions according to the invention comprise at least one viscosity modulating agent as an essential ingredient. The purpose of these agents is to increase the viscosity from the low initial value of the undiluted composition to a higher value upon dilution. The low viscosity helps the composition to easily penetrate a carrier, such as a sponge. Preferably, the undiluted composition has a viscosity below 500 mPas, more preferably at least 50 mPas, most preferably 250-350 mPas.

All viscosity measurements were made at about 25° C., using a Haake VT 550 viscometer at 106 s⁻¹ with an MVI spindle for measurements from 0 to 1000 mPas and at 21 s⁻¹ with an MVII spindle for measurements from 1000 to 8000 mPas.

The viscosity modulating agents comprise one or more electrolytes, organic solvents, and mixtures thereof. The compositions according to the invention comprise at least one electrolyte.

Electrolytes are water-soluble organic and inorganic salts (other than anionic surfactants), wherein the cation is chosen from alkali metals, alkaline earth metals, ammonium and mixture thereof and the anion is chosen from chloride, sulfate, phosphate, acetate, nitrate and mixtures thereof. Particularly useful are potassium, sodium and ammonium chloride.

The amount of electrolyte should be sufficient to increase the viscosity of the composition upon dilution. A useful amount of electrolyte in the compositions of the invention is from about 2.0% to about 4.5% by weight of the composition, more particularly between about 3.5% and about 3.9%. Furthermore, the ratio between the amount of surfactant and the amount of electrolyte is between about 4.3 and about 12, more particularly between about 9 and about 11.

Useful organic solvents to be added in addition to electrolytes as viscosity modulating agents are C1-C4 alkyl alcohols having one to three hydroxyl groups, and the concentration of said solvents is chosen so as to increase the viscosity. Preferred solvents are ethanol and/or propylene glycol, preferably each in an amount of about 2% to about 7% wt of the total composition.

The ratio of the amount of surfactant(s) to total viscosity modulating agent(s) (i.e. electrolytes+solvents) is preferably between 1 and 6.

Preferably the peak viscosity of the diluted composition is reached at a ratio of diluent to composition of between 1.5:1 and 2.5:1, most preferable at around 2:1 (e.g. between 1.8:1 and 2.2:1). Furthermore, the peak viscosity is at least 5 times the initial viscosity, preferably at least 10 times. Finally, the viscosity of the diluted composition exceeds the initial viscosity up to a dilution of at least 3.5:1 (diluent:composition). The diluent is preferably water or a mixture of solvents comprising water as the main solvent. More preferably the diluent is water.

### Optional Ingredients

The compositions of the invention optionally comprise other ingredients, such as fragrances, preservatives and colorants. Particularly colorants are useful to indicate the presence of the compositions in an absorbent carrier. Examples of useful colorants are: Blue FDC (CI: 42090); Patent blue (CI: 42051); Blue ABL 80 (CI: 61585); Red punzo No 7 (CI: 16255), Red Puricolor Are 14 (CI: 14720) and mixtures thereof.

The present invention also discloses a method for cleaning domestic surfaces, particularly hard surfaces, using the cleaning compositions according to the invention. The cleaning method of the invention has several advantages over known methods. In one aspect, it provides less consumption of cleaning composition and is therefore more economical and environmentally friendly.

The cleaning method of the invention comprises the steps of:
i) contacting a carrier with the composition of the invention;
ii) treating the combination of carrier and composition with water; and
iii) performing a cleaning operation of a surface with the carrier.

In an alternative, but less preferred variation, water can be added to the absorbent carrier before the composition is added to it.

A cleaning operation is typically represented by pressing the absorbent carrier to the surface and scrubbing it with circular movements, or in any other way, to aid in the removal of soil, grease or dirt from the surface. Dish surfaces and crockery are particular examples of household surfaces that can be cleaned with the composition of the invention.

Useful or absorbent or porous carriers are known, particularly the ones comprising voids where liquid can be stored, for instance, sponges (natural, polymeric, steel, etc), scouring pads, cloths. The composition is particularly suitable to be applied onto sponges in the cleaning method.

The ratio between the amount of water and the amount of cleaning composition to be used in the cleaning method according to the invention is preferably from about 0.5 to about 5, more preferably about 0.5-4, most preferably up to about 3.5.

The invention further provides a process for enhancing the retention of cleaning agents into a carrier comprising the steps of:
a) providing a solution of surfactants;
b) providing a solution of viscosity modulating agent;
c) mixing the solution of surfactants with the solution of viscosity modulating agent.

### DESCRIPTION OF THE DRAWINGS

FIG. 1 shows the viscosity profile of 4 known and commercially available compositions. One of those compositions, named Prior Art 1, displays viscosity increase of upon dilution; however it has an extremely poor performance and therefore it is not practical in use since the viscosity increase does not last upon continued dilution. Formulations A and B of the invention, on the other hand, do have the property of enhanced and sustained viscosity upon dilution, showing a peak of about 7,000 mPas which is reached with 20 g of water for Composition A and a peak of about 5,000 mPas for Composition B. FIG. 1 also shows that the retention of the compositions of the invention into the carrier increases upon dilution up to a ratio of diluent:cleaning composition of 2:1, since the viscosity increases during said dilution period up to a viscosity peak. FIG. 1 further shows the viscosity of the compositions of the invention is higher than their initial viscosity up to a ratio of diluent:cleaning composition of at least 3.5:1. On the other hand, previously known compositions sharply decreases in viscosity after the viscosity peak is reached and also at a much lower dilution ratio, thus substantially decreasing the practicality of the dilution-thickening effect in actual conditions of use.

FIG. 2 shows the comparison between a known composition that does not have the property of enhanced viscosity upon dilution (-♦-), and Formulation A (-▪-) and Formulation B (-□-) of the invention regarding the release of anionic surfactants from a sponge by the Direct Application method (standard soil/dose 3 grams). Wash liquor is discharged in the sink and collected for quantification of surfactants wasted on the article to be cleansed (in this case a plate). “x” axis represents the number of plates washed by the Direct Application method, while “y” axis represents the quantity in milligrams of anionic surfactants collected after said washings. It is clear from FIG. 2 that the compositions of the invention have much more controlled release of anionic surfactants when compared to the known composition.

### EXAMPLES

### Example 1

Cleaning compositions according to the invention were prepared according to the composition formulations below:

TABLE I
Composition A

| Chemical name | % w/w |
|---|---|
| Sodium laurylether sulfate C12-C13 2EO | 11 |
| Sodium laurylether sulfate C12-C14 1EO | 10.685 |
| Ethoxylated lauryl alcohol 7EO | 3 |
| Cocoamidopropyl betaine | 14.6 |
| Ethanol | 4.58 |
| Propylene Glycol | 7 |
| Citric acid | 0.13 |
| Fragrance | 0.2 |
| Ammonium Chloride | 3.73 |
| Formol | 0.08 |
| Disodium EDTA | 0.01 |
| Tartrazine Yellow | 0.001 |
| FDC Blue | 0.00025 |
| Water | to 100 |

Ratio surfactants: electrolyte is 10.6

TABLE II
Composition B

| Chemical name | % w/w |
|---|---|
| Sodium laurylether sulfate C12-C13 2EO | 10 |
| Sodium laurylether sulfate C12-C14 1EO | 9.72 |
| Fatty alcohol ethoxylated 7EO | 3 |
| Cocoamidopropyl betaine | 11.3 |
| Ethanol | 4 |
| Propylene Glycol | 3 |
| Citric acid | 0.12 |
| Fragrance | 0.2 |
| Ammonium Chloride | 3.73 |
| Formol | 0.08 |
| Disodium EDTA | 0.01 |
| Tartrazine Yellow | 0.001 |
| FDC Blue | 0.00025 |
| Water | to 100 |

Ratio surfactants: electrolyte is 9.2

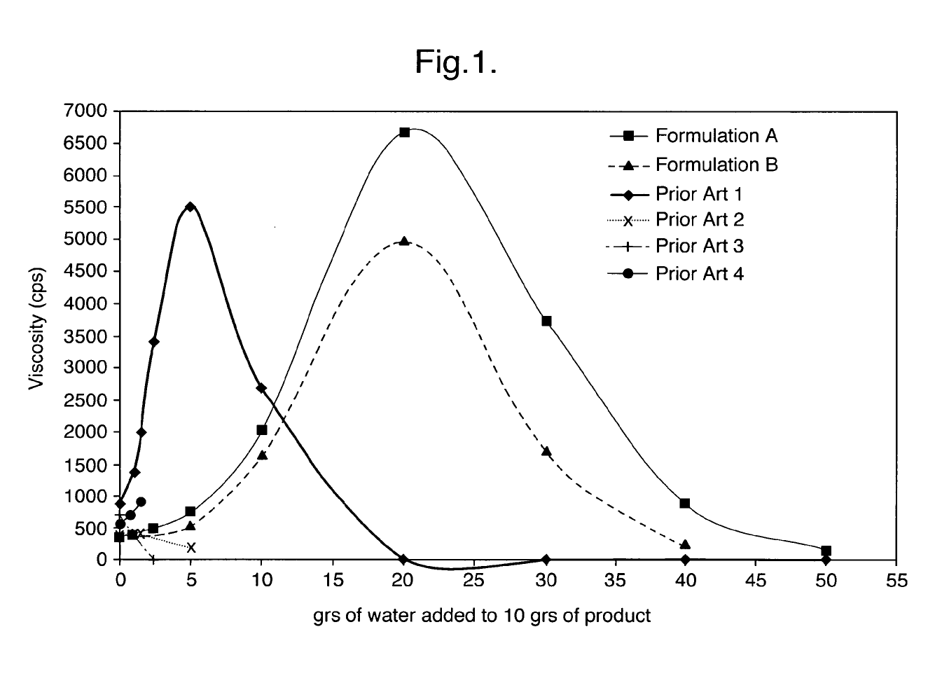

Water was added to the compositions above and viscosity change was measured for both compositions. The results are shown in FIG. 1 where it is shown that the viscosity reaches its peak for Compositions A and B when the weight ratio of water to cleaning composition is around 2 and an increased viscosity is maintained for a dilution ratio of at least 3.5:1. Also, the maximum viscosity value is at least 10 times higher the initial viscosity value.

This behavior is not obtained by any of the prior art compositions. Although Prior Art 1 composition also has increased viscosity upon dilution, this effect occurs in a very limited dilution range; its viscosity peak is reached when the ratio water:cleaning composition is 0.5:1, its viscosity peak is only 6.32 times higher than the initial viscosity and its increased viscosity is not maintained above a dilution rate of about 1.5:1.

A wash test was made comparing three compositions: Prior art composition (-♦-), Composition A (-▪-) of Table I and Composition B (-□-) of Table II. The washing method is the direct application method with a standard fat/flour/milk soil. Plates are soiled with the same amount of this soil and then washed in the following way:

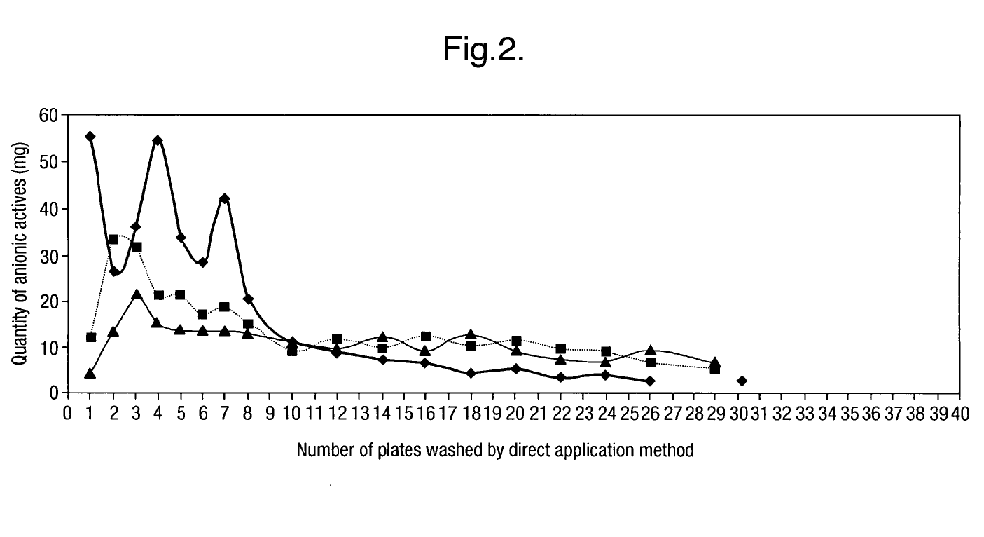

The dishwash product is poured directly on a wet sponge, some foam is generated and then each plate is washed with the same number of circular movements and then rinsed. The wash liquor is discharged in the sink and collected for quantification of surfactant wasted on each plate. The amount of anionic surfactant is quantified using a special electrode sensitive to anionic surfactants. The amount of anionic surfactant is plotted against the number of plates washed and the results are shown in FIG. 2, wherein one can clearly see that the compositions according to the invention provide a longer lasting and better controlled release of surfactant

A further composition according to the invention was prepared according to the Table III below:

TABLE III
Composition C

| Chemical name | % w/w |
|---|---|
| Sodium laurylether sulfate C12-C13 2EO | 9 |
| Sodium laurylether sulfate C12-C14 1EO | 9 |
| Ethoxylated lauryl alcohol 7EO | 3.2 |
| Cocoamidopropyl betaine | 14 |
| Ethanol | 2 |
| Propylene Glycol | 2 |
| Citric acid | 0.13 |
| Fragrance | 0.2 |
| Ammonium Chloride | 3.5 |
| Formol | 0.08 |
| Disodium EDTA | 0.01 |
| Tartrazine Yellow | 0.001 |
| FDC Blue | 0.00025 |
| Water | to 100 |

Ratio surfactants: electrolyte is 10

### Example 2

This example shows the beneficial effect of the presence of 2 alkyl ether sulphate anionic surfactants.

For this example 2 compositions are prepared (see table IV).

TABLE IV
Compositions D and E

| Ingredient | Composition D | Composition E |
|---|---|---|
| C12-C13 linear alkyl ether | 8.07 | 8.07 |
| sulphate (1EO) *⁾ | | |
| C12-C13 branched alkyl ether | 7.88 | 7.88 |
| sulphate (1EO) **⁾ | | |
| Coco-amido propyl betaine | 6.85 | 6.85 |
| Ethoxylated lauryl alcohol 7EO | 2.2 | 3 |
| Ammonium chloride | 2.75 | |
| Sodium chloride | | 4 |
| Propylene glycol | 5.1 | 3 |

*⁾ Texapon N70, ex Cognis;
**⁾ In house sulphated Lialet-123, ex Sasol

Water was added to the compositions above and viscosity change was measured for both compositions.

The results are shown in Table V below. The table shows the viscosity of the pure product (100%) and dilutions of 70%. 60%, 50%, 40% and 30% product in tap water.

TABLE V
results

| | Viscosity (mPa · s) | Viscosity (mPa · s) |
|---|---|---|
| | Composition D | Composition E |
| 100% | 420 | 620 |
| 70% | 1530 | 6180 |
| 60% | 3940 | 6580 |
| 50% | 6780 | 4740 |
| 40% | 4380 | 2930 |
| 30% | 830 | 340 |

Both compositions show a good thickening effect, reaching up to more than 10 times the initial viscosity. The table also shows that the position of the ‘viscosity peak’ can be fine-tuned by the choice and concentration of electrolyte and solvent.

1. Dilution-thickening aqueous liquid cleaning compositions comprising:
at least two anionic surfactants which are both alkalimetal alkylether sulphates;
at least one electrolyte as a viscosity modulating agent;
wherein the ratio of the amount of surfactants to the amount of electrolyte is between about 4.3 and about 12.

2. Cleaning compositions according to claim 1 wherein the anionic surfactant is C₁₀-C₁₈ alkylether sulfate salt with 1-4 EO groups.

3. Cleaning compositions according to claim 1 wherein the composition additionally comprises an amphoteric surfactant.

4. Cleaning compositions according to claim 3 wherein the amphoteric surfactant is a C₁₀-C₁₈ alkylamidopropyl betaine.

5. Cleaning compositions according to claim 4 wherein the weight ratio between the amount of anionic surfactants and the amount of amphoteric surfactant is from about 1.3 to about 1.9.

6. Cleaning compositions according to claim 5 wherein the amount of amphoteric surfactant 10-18% by weight of the composition.

7. Cleaning compositions according to claim 1 wherein, in addition to the electrolyte, the composition comprises an organic solvent as a viscosity modulating agent.

8. Cleaning compositions according to claim 1 wherein the electrolyte is chosen from: water soluble organic and inorganic salts, wherein the cation is chosen from alkali metals, alkaline earth metals, ammonium and mixture thereof and the anion is chosen from chlorides, sulfates, phosphates, acetates, nitrates and mixtures thereof.

9. Cleaning compositions according to claim 8 wherein the water-soluble salt is potassium, sodium or ammonium chloride or a mixture thereof.

10. Cleaning composition according to claim 8 wherein the amount of salt is 2.0-4.5% by weight of the composition.

11. Cleaning compositions according to claim 7 wherein the organic solvents are chosen from C1-C4 alkyl alcohols having one to three hydroxyl groups in an amount sufficient to increase viscosity of the composition.

12. Cleaning compositions according to claim 11 wherein the organic solvent is chosen from ethanol and/or propylene glycol in an amount of between 2% and 7% of the composition.

13. Cleaning compositions according to claim 1 wherein the initial viscosity is between 50 and 500 mPas and which on dilution to one part of composition with between 1.5 and 2.5 reach a peak viscosity of ate least 5 times the initial viscosity.

14. Cleaning compositions according to claim 13 wherein the initial viscosity is between 250 and 350 mPas and the peak viscosity is at least 10 times higher.

15. Method to clean hard surfaces comprising the steps of:
i) contacting a carrier with a composition according to claim 1.
ii) treating the combination of carrier and composition with water; and
iii) performing a cleaning operation of a surface with the carrier.
